(19) United States
(12) Patent Application Publication
(10) Pub. No.: US 2026/0186976 A1
(43) Pub. Date: Jul. 2, 2026

(54) Method for Managing a Cache Memory and a Cache Management System

(71) Applicant: MEDIATEK INC., Hsinchu City (TW)

(72) Inventors: Yu-Wei Wang, Hsinchu City (TW); Po-Han Wang, Hsinchu City (TW); Ming-Hung Hsieh, Hsinchu City (TW); Sheng-Wei Liao, Hsinchu City (TW); Yu-Xin Lin, Hsinchu City (TW); Sheng-Kai Lin, Hsinchu City (TW); Ke-Jen Lin, Hsinchu City (TW)

(73) Assignee: MEDIATEK INC., Hsinchu City (TW)

(21) Appl. No.: 19/330,784

(22) Filed: Sep. 16, 2025

Related U.S. Application Data
(60) Provisional application No. 63/739,709, filed on Dec. 30, 2024.
(60) Provisional application No. 63/739,710, filed on Dec. 30, 2024.
(60) Provisional application No. 63/742,471, filed on Jan. 7, 2025.

(51) Int. Cl. G06F 12/0891; G06F 12/0871; G06F 12/126

(52) U.S. Cl. CPC G06F 12/0891; G06F 12/0871; G06F 12/126

(57) ABSTRACT

A method for managing a cache memory is provided. The method includes associating a dataset with a cache maintenance operation (CMO) mode, wherein the CMO mode is a deferred mode. The method further includes storing a deferred CMO hint in a metadata portion of a cache line within the cache memory; storing a dataset identifier in the metadata portion of the cache line to associate the cache line with the dataset; receiving a trigger command associated with the dataset identifier; and performing the deferred CMO on one or more cache lines in the cache memory associated with the dataset identifier based on the trigger command.

### CROSS REFERENCE TO RELATED APPLICATIONS

This application claims the benefit of U.S. Provisional Application No. 63/739,709, filed on Dec. 30, 2024. Further, this application claims the benefit of U.S. Provisional Application No. 63/739,710, filed on Dec. 30, 2024. Further, this application claims the benefit of U.S. Provisional Application No. 63/742,471, filed on Jan. 7, 2025. The contents of these applications are incorporated herein by reference.

### BACKGROUND

In modern computing systems, the cache memory temporarily stores data to improve system performance. Cache Maintenance Operations (CMOs) are used to manage cache contents for efficiency or data coherency. For efficiency, a “flush” operation may be used to evict a cache line and write any dirty data back to the main memory, while a “discard” operation evicts the cache line without a write-back, which is suitable for data that is no longer needed.

Conventional CMOs are address-based and are executed immediately upon receipt. This CMO approach suffers from several limitations. First, it is inefficient for large data footprints. For example, a user must issue a separate command for each address segment, requiring a massive number of commands to traverse a large dataset (e.g., 1 gigabyte) even if only a small portion resides in the cache (e.g., 1 megabyte). As a result, the conventional CMO process is both inefficient and power-intensive.

Second, users face practical difficulties in applying these CMOs. Often, a user only knows a dataset is disposable after an entire job is complete, by which time the specific addresses associated with that job may have been forgotten. Moreover, in a job that may require a plurality of processes to complete, data is shared among these processes. A single user or process cannot ascertain whether it is the final entity to use the data. It implies that a discard command in such a scenario is risky, as it could lead to data loss for other concurrent users. However, once the entire job is complete, the system can then determine with certainty that the dataset associated with that job is no longer needed and can be safely discarded.

Therefore, a need is required to design a more efficient, flexible, and safer cache management mechanism that overcomes the challenges posed by traditional, immediate, address-based CMOs.

### SUMMARY

In an embodiment, a method for managing a cache memory is disclosed. The method comprises associating a dataset with a cache maintenance operation (CMO) mode, wherein the CMO mode is a deferred mode; storing a deferred CMO hint in a metadata portion of a cache line within the cache memory; storing a dataset identifier in the metadata portion of the cache line to associate the cache line with the dataset; receiving a trigger command associated with the dataset identifier; and performing the deferred CMO on one or more cache lines in the cache memory associated with the dataset identifier based on the trigger command.

In another embodiment, a cache management system is disclosed. The cache management system comprises a cache memory and a controller. The cache memory comprises a plurality of cache lines. A metadata portion of at least one of the plurality of cache lines is configured to store a deferred cache maintenance operation (CMO) hint and a dataset identifier to associate the at least one cache line with a dataset. The controller is coupled to the cache memory. The controller is configured to associate the dataset with a deferred CMO mode. The controller is configured to receive a trigger command associated with the dataset identifier. The controller is configured to perform a deferred CMO on one or more of the plurality of cache lines associated with the dataset identifier based on the trigger command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a cache management system 100 according to an embodiment of the present invention.

FIG. 2 is a conceptual diagram illustrating two exemplary scenarios for triggering the deferred CMOs of the cache management system 100 in FIG. 1.

FIG. 3 is a flowchart illustrating a method for processing a Cache Maintenance Operation (CMO) hint in the cache management system in FIG. 1.

FIG. 4 is a state machine diagram illustrating the transitions between the four states based on 2-bit CMO hints in each cache line of the cache management system 100 in FIG. 1.

FIG. 5 is a state machine diagram illustrating the transitions for the 1-bit CMO hints of the cache management system 100 in FIG. 1.

FIG. 6 to FIG. 10 are flowcharts illustrating sanity check protection mechanisms of the cache management system 100 in FIG. 1.

FIG. 11 is a flowchart illustrating a method performed by the hardware-based Garbage Collection (GC) engine to execute pending deferred CMOs of the cache management system in FIG. 1.

FIG. 12 is a detailed data flow diagram illustrating a working example of the GC engine executing a deferred “Buffer-discard” operation of the cache management system 100 in FIG. 1.

FIG. 13 is a flowchart illustrating a process of the execution on eviction mechanism performed by the cache management system 100 in FIG. 1.

### DETAILED DESCRIPTION

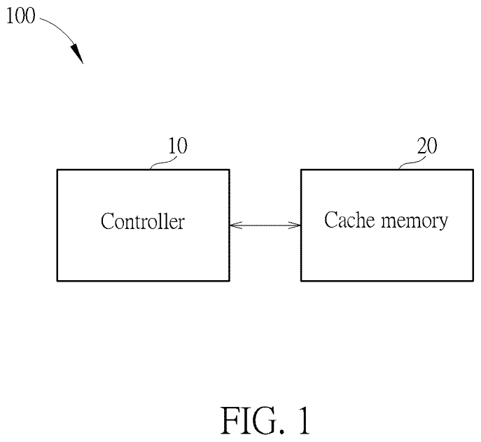

FIG. 1 is a block diagram illustrating a cache management system 100 according to an embodiment of the present invention. The cache management system 100 may be implemented within a System-on-Chip (SoC) for various electronic devices such as smartphones, tablets, or computers. As shown, the cache management system 100 comprises at least a controller 10 and a cache memory 20. The cache management system 100 is configured to implement a deferred, dataset-based cache maintenance operation (CMO).

The cache memory 20 is a hardware memory component, such as a system-level cache (SLC), configured to temporarily store data to reduce memory access latency. The cache memory 20 comprises a plurality of cache lines, which are the fundamental units for data storage and management. Each cache line includes a metadata portion configured to store information critical to the deferred CMO mechanism. The metadata includes at least a dataset identifier (e.g., a Buffer ID) that associates the cache line with a specific logical dataset, and a deferred CMO hint that indicates a future maintenance operation intended for the data in that cache line. The deferred CMO hint may be represented, for example, by a plurality of state bits (e.g., 2 bits) or a single flag (e.g., a 1-bit non-discardable flag).

The controller 10 is a hardware control logic coupled to the cache memory 20. The controller 10 is configured to manage and execute the entire deferred CMO process. Further, the controller 10 is configured to receive commands from one or more upstream users (e.g., a GPU, CPU, or device driver). In a standard computing system, an application does not allocate hardware resources, such as memory buffers, directly. Instead, the application sends a request to an operating system (OS) or a device driver. The device driver, upon allocating a dataset (e.g., a buffer) for the application, is then the logical entity to also assign the corresponding dataset identifier (Buffer ID) that is used by the cache management system 100. The commands received by the controller 10 include initial CMO hints for specific memory addresses, which the controller 10 uses to encode the deferred CMO hints into the metadata of the corresponding cache lines.

Moreover, the controller 10 is configured to receive a trigger command (e.g., a Buffer-flush or Buffer-discard command) that is associated with a specific dataset identifier. Upon receiving the trigger command, the controller 10 performs the deferred CMO on all cache lines within the cache memory 20 that are associated with the specified dataset identifier. The CMO execution can be carried out through various embodiments managed by the controller 10, such as by initiating an active background traversal process (i.e., a garbage collection or GC engine) to scan the cache memory 20, or by passively executing the operation on a cache line when it is selected as a victim for eviction. The controller 10 also implements protection mechanisms, ensuring data integrity when a dataset identifier is reused. Details of operation of the cache management system 100 are illustrated below.

To provide flexibility, the cache management system 100 is configured to support both conventional immediate CMOs and the deferred CMOs. The desired CMO behavior can be dynamically selected on a per-dataset basis, for example, by associating a specific CMO mode with each dataset identifier (or Buffer ID). In an embodiment, these modes include an “Immediate CMO” mode and a “Deferrable CMO” mode. The Immediate CMO mode corresponds to traditional cache maintenance operations. When a Buffer ID is configured for this mode, any received CMO command associated with the Buffer ID is performed immediately without delay. The Immediate CMO mode is particularly suitable for operations where data coherency is a primary concern.

The Deferrable CMO mode is a core aspect of the embodiment. When a Buffer ID is configured for this mode, received CMO commands are not executed immediately. Instead, a corresponding CMO hint is recorded or encoded into the metadata of the target cache lines for future execution. The Deferrable CMO mode can be further categorized into at least two sub-types to offer different levels of operational safety and efficiency, such as Deferrable, Flush-only (Type 1) and Deferrable, Flush or discard (Type 2).

In type 1 (Flush-only and Deferrable), this is a conservative deferred mode that disallows discard-type operations. If a discard-type CMO is received for a buffer in this mode, the controller 10 will downgrade the request to a flush-type operation. This ensures that data, even if marked for discard, will be safely written back to a downstream memory, which is useful for data that may be shared or have uncertain usage patterns. Type 2 (Deferrable, Flush or discard) is a more aggressive deferred mode that permits both flush-type and discard-type operations. The CMO operations in type 2 achieve maximum efficiency by enabling true discards (i.e., evicting a dirty cache line without write-back) when a user is confident that the data is no longer needed. Table T1 illustrates an exemplary configuration of these CMO modes assigned to various upstream users or their corresponding buffers.

TABLE T1

| Buffer ID | Deferred Mode |
|---|---|
| CPU | Immediate CMO |
| GPU | Deferred Mode, Flush Only |
| NPU | Deferred Mode, Flush or Discard |
| MM | Immediate CMO |

As shown in Table T1, a mapping can be maintained by the system to define the CMO behavior for each Buffer ID. For instance, buffers associated with a CPU or with Multi-media (MM) logic may be set to “Immediate CMO”. For certain users, such as a CPU, a CMO is initiated by a software program. In these scenarios, the software's logic has determined a necessity for the CMO to be executed at that precise moment, and thus, the operation cannot be deferred. The immediate requirement is often tied to ensuring program-level data coherency. Therefore, to honor the program's explicit operational demands, such requests are handled in the “Immediate CMO” mode to be performed without delay. In contrast, a buffer used by a GPU may be configured for the safer “Deferred Mode, Flush Only”. A buffer for a Neural Processing Unit (NPU), which may process large amounts of intermediate data that quickly become obsolete, could be set to “Deferred Mode, Flush or Discard” to maximize cache efficiency. The per-buffer configuration in Table T1 leads the cache management system 100 to adapt dynamically to the specific needs of different applications and data types within the SoC.

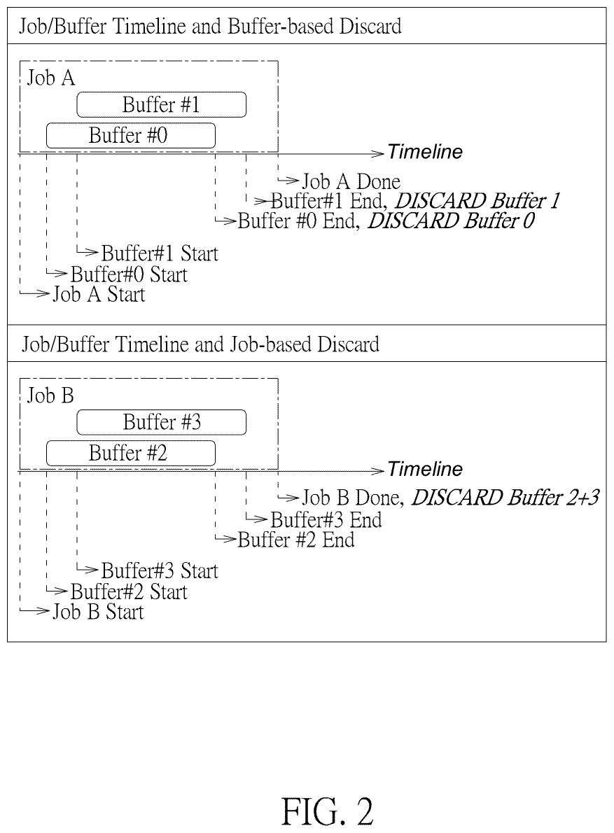

FIG. 2 is a conceptual diagram illustrating two exemplary scenarios for triggering the deferred CMOs of the cache management system 100. Both scenarios depict timelines for data buffers used within concurrent jobs, demonstrating flexible trigger granularities. The top diagram in FIG. 2 illustrates a “Buffer-based Discard” scenario, which involves Job A utilizing a first set of data buffers that includes Buffer #0 and Buffer #1. In this mode of operation, the user or system can issue a separate trigger command for each individual data buffer as its specific task concludes. For instance, the timeline shows that after the usage of Buffer #0 ends, a specific “DISCARD Buffer 0” trigger command is issued. Subsequently, at a later point in time when the usage of Buffer #1 ends, an independent “DISCARD Buffer 1” trigger command is issued. The Buffer-based Discard approach provides fine-grained control over the lifecycle of each data buffer in the cache memory 20.

The bottom diagram in FIG. 2 illustrates a “Job-based Discard” scenario, which involves Job B utilizing a second set of data buffers that includes Buffer #2 and Buffer #3. In this mode, the trigger command is issued for a group of buffers that are logically associated with a larger task or job. As depicted in the timeline, individual tasks for Buffer #2 and Buffer #3 may end at different times, but the trigger command is withheld until the entire Job B is complete. Upon completion of Job B, a single trigger command, “DISCARD Buffer 2+3”, is issued to perform the deferred CMOs on all buffers that were used by Job B. The Job-based Discard approach offers convenience by enabling a user to release all resources related to a job with a single command, without needing to track the state of each individual buffer.

Therefore, FIG. 2 demonstrates that the cache management system 100 enables the trigger command's granularity to be flexibly defined. The system supports cache cleanup on either a per-dataset (buffer-based) or a grouped-dataset (job-based) basis, depending on the application's specific requirements and the user's capability.

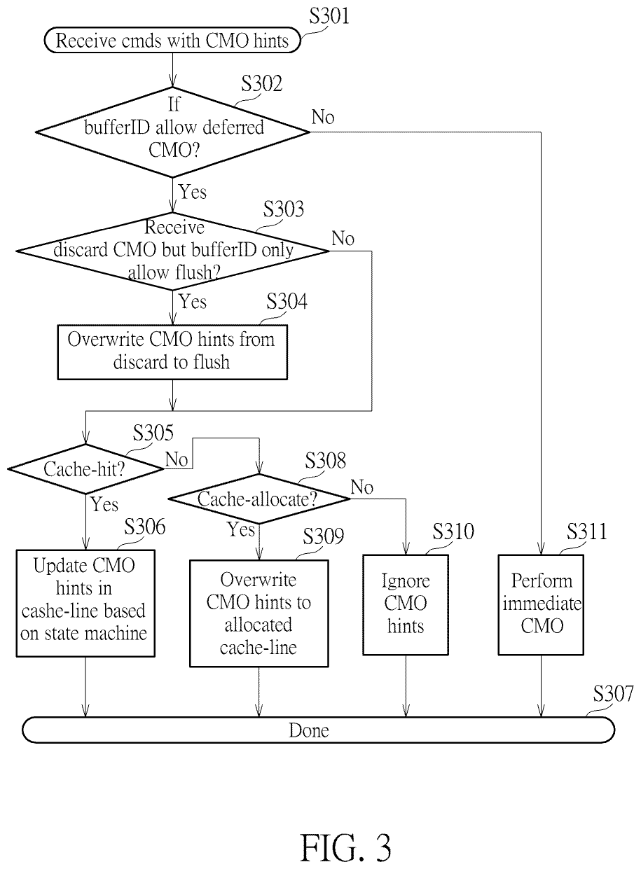

FIG. 3 is a flowchart illustrating a method for processing a CMO hint in the cache management system 100. The process steps S301 to S311 are performed by the controller 10 to determine whether a CMO should be executed immediately or deferred, and how to record the hint in the cache memory 20. Any technology or hardware modification falls into the scope of the embodiments. Steps S301 to S311 are illustrated below.

The process begins at step S301, where the controller 10 receives commands with CMO hints from an upstream user. Each command may be one of several types: a standalone CMO command, or a memory access command, such as a read request or a write request, that is accompanied by a CMO hint. Regardless of the command type, each received command and its associated CMO hint are linked to a particular memory address and its corresponding Buffer ID. At step S302, the controller 10 first checks the operational mode associated with the Buffer ID of the incoming CMO hint. The check determines if the dataset is configured for deferred operations. The mapping of Buffer IDs to CMO modes may be configured as previously illustrated in Table T1. If the Buffer ID is not configured to allow deferred CMO (the “No” branch from S302), the process proceeds to step S311. In step S311, the controller 10 performs the CMO immediately, consistent with traditional cache operation, after which the process concludes at step S307.

If the Buffer ID does allow deferred CMO (the “Yes” branch from S302), the controller 10 performs a safety check at step S303. Step S303 determines if there is a conflict between the received CMO hint and the buffer's configured mode. Specifically, it checks if the CMO hint is a “discard” type CMO, while the buffer's mode is the more conservative “Flush-only”. If such a conflict exists (the “Yes” branch from S303), the process moves to step S304, where the controller 10 overwrites or downgrades the CMO hint from “discard” to “flush” to ensure data is not unintentionally lost. If there is no conflict (the “No” branch from S303), step S304 is bypassed.

Next, at step S305, the controller 10 checks if the data corresponding to the CMO hint's address is currently stored in the cache memory 20 (i.e., a cache hit). If a cache hit occurs (the “Yes” branch from S305), the process proceeds to step S306. At this step, the controller 10 updates the metadata portion of the existing cache line. For example, it may update the 2-bit CMO state machine or the 1-bit non-discardable flag to reflect the received (and possibly downgraded) CMO hint. The process then concludes at step S307.

If a cache miss occurs (the “No” branch from S305), the process proceeds to step S308 to determine whether to allocate a new cache line for the data. The decision may depend on the type of memory access (e.g., a write operation would cause an allocation). If the controller 10 decides to allocate a new cache line (the “Yes” branch from S308), it proceeds to step S309. At step S309, the CMO hint is written into the metadata of the newly allocated cache line as the data is brought into the cache memory 20. If the controller 10 decides not to allocate a new line (the “No” branch from S308), it proceeds to step S310, and the CMO hint is ignored or dropped, as there is no cache line in which to store it. Following steps S309 or S310, the process for the current hint is completed at step S307.

The cache management system 100 may implement various embodiments to store the deferred CMO hint in the metadata of each cache line. One embodiment utilizes a 2-bit field, hereinafter referred to as “CMO bits”, for each cache line to define its deferrable CMO status. The definitions for these CMO bits are presented in Table T3, and the user-triggered commands for executing the deferred operations are shown in Table T4.

TABLE T3

| CMO Bits | Description |
|---|---|
| 0b00 | Disallow Defer CMO. Only immediately |
| 0b01 | Allow Defer CMO, Waiting CMO |
| 0b10 | Deferred, Flush-only |
| 0b11 | Deferred, Allow Discard |

Table T3 illustrates the four possible states represented by the 2-bit CMO bits in a cache line's metadata. State “0b00” indicates that the cache line does not support deferred CMOs. This state is for data associated with a Buffer ID set to “Immediate CMO” mode, where any CMO must be executed without delay. State “0b01” represents a neutral or initial state for a deferrable cache line. It signifies that deferred operations are permitted for this line, but no specific flush or discard hint has yet been received. State “0b10” represents a “Deferred, Flush-only” pending state. When a cache line is in this state, it is marked for a future flush operation, which requires its data to be written back to a downstream memory upon eviction. State “0b11” represents a “Deferred, Allow Discard” pending state. This state indicates that the cache line is marked for a future discard operation, permitting the controller 10 to invalidate the line without writing its contents back, even if dirty.

TABLE T4

| Do Flush | Do Discard | Description/Cache Behavior |
|---|---|---|
| 0 | 0 | User is not yet to do CMO right now. |
| 0 | 1 | Do CMO, try to discard all cache lines. |
| 1 | 0 | Do CMO, flush all cache lines. |
| 1 | 1 | Undefined behavior. Do flush CMO only. |

It should be understood that Table T3 defines the states of a state machine maintained within the metadata of each individual cache line. These states are represented by a 2-bit field, referred to as “CMO bits,” which records the pending deferred operation for that specific cache line. In contrast to the per-cache-line states, Table T4 defines the high-level trigger commands that a user can issue to initiate the execution of all pending deferred operations for an entire dataset. These commands are stored as flags within a Buffer ID Status Table. For example, by setting flags in a status table for a specific Buffer ID, to initiate the execution of the pending deferred CMOs. When both Do Flush and Do Discard are 0, the cache management system 100 remains idle, and no execution is triggered. Setting “Do Discard” to 1 (while “Do Flush” is 0) corresponds to a “Buffer-discard” trigger. The controller 10 will then traverse the cache and execute pending operations, attempting to discard lines in state “0b11” and flush lines in state “0b10”. Setting “Do Flush” to 1 (while “Do Discard” is 0) corresponds to a “Buffer-flush” trigger. This is a safer command that forces all pending operations (for both “0b10” and “0b11” states) to be executed as flushes. If both flags are set to 1, this is treated as an undefined state. To ensure data safety, the cache management system 100 defaults to the most conservative action which performs a flush-only operation.

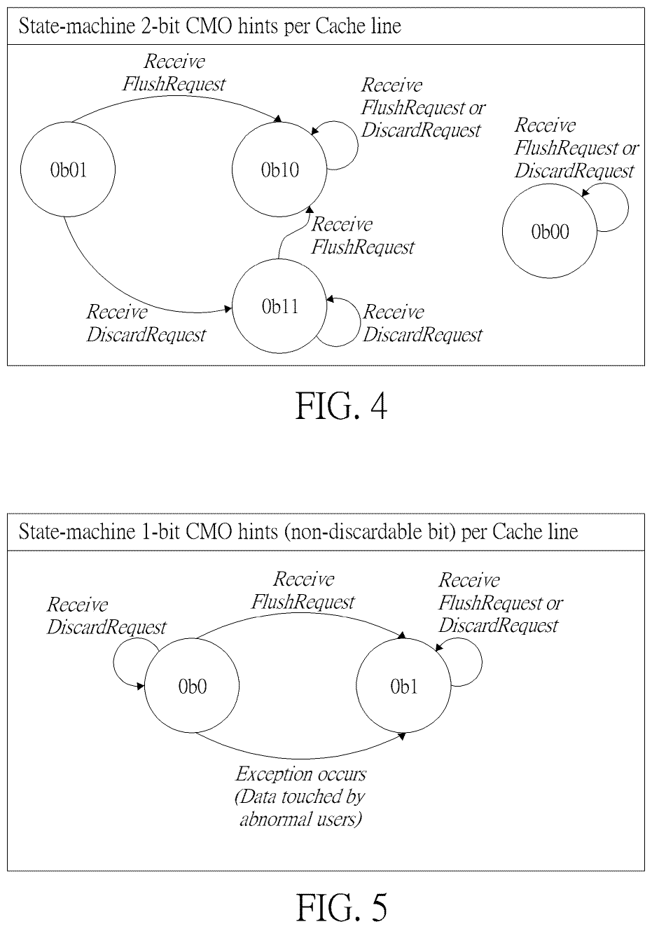

FIG. 4 is a state machine diagram illustrating the transitions between the four states defined in Table T3, based on 2-bit CMO hints in each cache line (Flush Request or Discard Request) of the cache management system 100 received during a job's execution. The state “0b01” is an initial state for a cache line in a deferrable buffer. Upon receiving a Flush Request, the cache line transitions from state “0b01” to state “0b10” (“Deferred, Flush-only”). Upon receiving a Discard Request, it transitions from “0b01” to state “0b11” (“Deferred, allow discard”).

State “0b10” is a conservative pending state. Once a cache line enters this state, it cannot become more aggressive. As shown in FIG. 4, receiving a Discard Request while in state “0b10” does not cause a transition to “0b11”; the state remains “0b10”. It ensures a line marked for a safe flush cannot be accidentally converted to a discardable state. State “0b11” is the aggressive pending state. If a Flush Request is received while the line is in state “0b11”, its state is “downgraded” to the safer state “0b10”. This transition provides a mechanism for a user to reverse a previous discard decision and enforce a write-back if conditions change. Finally, state “0b00” is an absorbing state for non-deferrable cache lines. Once a line is in this state, any incoming request (e.g., All Requests) will not change its state, reinforcing its immediate-only behavior.

An alternative embodiment for storing the deferred CMO hint utilizes a single bit, hereinafter referred to as the non-discardable bit, in the metadata of each cache line. In the single bit CMO hint scenario, all deferrable cache lines are considered discardable by default, unless explicitly marked otherwise by an incoming request or a system event. The definitions for the non-discardable bit are presented in Table T5. The execution of the deferred operations is subsequently initiated by the trigger commands previously defined in Table T4.

TABLE T5

| Non-discard | Description |
|---|---|
| 0b0 | Allow Defer CMO(Waiting) or Deferred |
| | Discard |
| 0b1 | Disallow Defer CMO or Deferred Flush |

Table T5 illustrates the two possible states represented by the single non-discardable bit. State “0b0” is the default state for a deferrable cache line, indicating that the line is discardable. When the bit is “0”, it signifies that either no specific hint is pending (“Waiting”) or that a Discard Request has been received. A Buffer-discard trigger command can invalidate a line in this state without a write-back. State “0b1” indicates that the cache line is non-discardable. When the bit is set to “1”, any pending or future deferred CMO for this line must be treated as a flush, ensuring its data is written back to a downstream memory. This state can be regarded as a “safe” marker for the cache line.

FIG. 5 is a state machine diagram illustrating the transitions for the 1-bit CMO hints of the cache management system 100. A deferrable cache line begins in the initial state “0b0”, signifying it is discardable. Receiving a Discard Request while in this state does not change the state. It remains “0b0” because the line is already considered discardable. The transition from the discardable state “0b0” to the non-discardable state “0b1” is a one-way, irreversible transition that occurs under specific conditions to ensure data safety. These conditions include (a) Receiving a Flush Request and (b) an Exception Occurs. For (a), if a Flush Request is received for a line in state “0b0”, the line must be written back. Therefore, its state transitions to “0b1” to enforce this requirement. For (b), the transition can also be triggered by an exceptional system event, such as when data is “touched by abnormal users”. For example, if data in a buffer expected to be used only by a GPU is also accessed by a CPU, this unexpected sharing creates uncertainty. To be conservative, the controller 10 will force the cache line's state to “0b1” to prevent an unsafe discard.

State “0b1” is an absorbing or immutable state. As shown in FIG. 5, once the non-discardable bit is set to “1”, any subsequent request (e.g., All Requests) including either a Flush Request or a Discard Request, will not change the state back to “0b0”. This guarantees that once a cache line is marked as requiring a safe write-back, that requirement cannot be revoked by a later, more aggressive CMO hint.

Further detailing the implementation of the deferred CMO mechanism, the following paragraph describes a specific embodiment based on the 2-bit CMO bits previously introduced. This implementation depends on specific data structures within the cache memory 20 and a corresponding processing logic within the controller 10.

TABLE T6

| Tag | Cache Status | LRU- | Buffer | Evict- | CMO- | |
|---|---|---|---|---|---|---|
| Address | (MOESI) | bit(s) | ID | first | bits | Parity |
| 0xdeadbeef | Valid | 1 | NPU | 0 | 0b11 | xx |

Table T6 illustrates an exemplary structure for the metadata stored within the tag SRAM of each cache line in the cache memory 20. Alongside standard fields such as Tag Address and Cache Status, this embodiment includes several fields, as illustrated below. The field of Buffer ID stores the identifier that associates the cache line with a specific dataset or user. The field of Evict-first is a 1-bit flag that, when set, signals the cache's replacement policy to prioritize this cache line for eviction. The Evict-first bit can facilitate an efficient, non-blocking execution of deferred operations by avoiding immediate mass write-backs. The field of CMO-bits is a 2-bit field that stores the deferred CMO state for the cache line, corresponding to one of the four states (“0b00” to “0b11”) defined in Table T3. The field of LRU-bit(s) stores the Least Recently Used (LRU) information for the cache line. The LRU bits are used by the cache's replacement policy to determine which cache line should be selected as a victim for eviction when a new line needs to be allocated.

TABLE T7

| | | Do | |
|---|---|---|---|
| Buffer ID | Deferred Mode | Flush | Do Discard |
| CPU | Immediate CMO | 0 | 0 |
| GPU_Buf0 | Deferred Mode, Flush-only | 0 | 0 |
| GPU_Buf1 | Deferred Mode, Flush-only | 0 | 0 |
| NPU_Buf0 | Deferred Mode, Flush-or-Discard | 0 | 1 |
| NPU_Buf1 | Deferred Mode, Flush-or-Discard | 0 | 0 |
| ISP_Buf0 | Deferred Mode, Flush-or-Discard | 0 | 0 |
| ISP_Buf1 | Immediate CMO | 0 | 0 |

Table T7 shows an exemplary Buffer ID attribute and status table that can be maintained by the controller 10. For each Buffer ID, the table stores its pre-configured Deferred Mode and its runtime status flags, “Do Flush” and “Do Discard”. These flags are set to “1” when a user issues a corresponding trigger command. For example, Table T7 shows that a “Buffer-discard” trigger command is currently active for NPU_Buf0, as its “Do Discard” flag is set to “1”.

When a trigger command is active for a given Buffer ID, the controller 10 executes a specific logic for each associated cache line, for instance, during a background traversal. The processing logic is as follows. When a “Buffer-discard” trigger command is active for a given Buffer ID (i.e., “Do Discard” is “1” and “Do Flush” is “0”), the specific action performed by the controller 10 on an associated cache line is contingent upon the state of that cache line's “CMO-bits” metadata. Specifically, only if the cache line's “CMO-bits” are in a state that permits discard (e.g., state “0b11” for “Deferred, Allow Discard”), the controller 10 will set the dirty bit of the cache line to “0” and discard the data without a write-back. Conversely, if the cache line's “CMO-bits” indicate a flush-only policy (e.g., state “0b10”), the controller 10 will perform a flush operation instead of a discard, even under a “Buffer-discard” command. If the command is a “Buffer-flush” (Do Flush is “1”), the controller 10 enforces a safe flush by ensuring the line becomes non-discardable (e.g., by transitioning the CMO-bits from “0b11” to “0b10”), overriding the original discard hint.

It should be understood that for any cache line associated with a triggered Buffer ID and having a pending deferred hint (e.g., its CMO-bits are in state “0b10” or “0b11”), the controller 10 sets the Evict-first bit of that cache line to “1”. This action marks the line for prioritized eviction but does not immediately stall the process to perform a write-back. The Evict-first flag can be regarded as a hint to the cache's replacement policy, which will then select this line as a preferred victim when a future allocation requires space.

An important issue of the deferred CMO mechanism is ensuring data integrity in the presence of certain race conditions. A protection mechanism, or “sanity check”, is implemented by the controller 10 to handle a specific protected condition that may arise during operation. The sanity check condition occurs through the following sequence of events. For example, first, an upstream user, such as a NPU, determines that a dataset associated with a specific Buffer ID (e.g., BUF1) is no longer needed. The user then issues a trigger command, for example, a “Buffer-discard” command to the controller 10. In response, the cache management system 100 begins executing the deferred CMO process, for instance, by initiating a background traversal to find and operate on all cache lines marked with BUF1. This process takes a non-zero amount of time to complete.

Next, before the deferred CMO process for BUF1 has finished, the NPU re-uses the exact same Buffer ID, BUF1, for a new job, and begins to write or allocate new data into the cache memory 20. This is possible because the user is not required to poll for the completion of the background cleanup. At this point, the cache memory 20 may simultaneously contain both old data marked for discard and new, valid data. Specifically, both old and new data are associated with the identical Buffer ID (BUF1), and the controller 10 cannot distinguish between them. The ambiguity creates a significant risk. That is, the new, valid data belonging to the re-used Buffer ID could be unintentionally and erroneously discarded by the still-ongoing deferred CMO process, leading to data corruption. Therefore, a protection mechanism is required to prevent such unintentional data loss. Details are illustrated below.

One embodiment of the protection mechanism is triggered when the controller 10 receives a new CMO hint for a Buffer ID that is already undergoing a deferred discard process. To guarantee data correctness, the controller 10 first performs a sanity check on the status of the Buffer ID associated with the incoming CMO hint. If the controller 10 determines that a “Buffer-discard” trigger is currently active for that Buffer ID, it applies a protection measure to the newly received CMO hint to prevent the data associated with this new hint from being accidentally discarded. The controller 10 may be configured to apply one of the following solutions.

In a first solution, the controller 10 is configured to simply ignore or drop the newly received CMO hint. By not encoding this new hint into any cache line's metadata, the cache management system 100 ensures that the data corresponding to the new CMO hint will not be affected by the ongoing discard operation for the older dataset. The first solution provides a straightforward method to prevent data corruption.

In a second solution, the controller 10 is configured to convert the new CMO hint into a “Flush-only” state, regardless of its original type. For instance, if the incoming CMO hint is a “Discard Request”, the controller 10 will downgrade it and force the corresponding cache line's metadata into a safe, non-discardable state (e.g., state “0b10” in the 2-bit embodiment). The second solution approach is advantageous as it still preserves the user's intent to perform a cache maintenance operation while completely mitigating the risk of incorrect data discard.

Another embodiment of the protection mechanism is triggered when the controller 10 receives a new memory allocation request for a Buffer ID that is already undergoing a deferred discard process. An allocation request can be part of, for example, a write operation to an address that is not currently in the cache. Upon receiving the allocation request, the controller 10 performs a sanity check on the status of the associated Buffer ID. If the controller 10 determines that a “Buffer-discard” trigger is currently active for that Buffer ID, it applies a protection measure to the data being newly allocated to prevent it from being erroneously discarded by the ongoing process. The controller 10 may be configured to apply one of the following solutions.

In a first solution, the controller 10 is configured to handle the allocation request by forcing the new data to be non-cacheable (or “non-allocate”). It implies that the data is not written into the cache memory 20. Instead, it may be written directly to a downstream memory. The first solution approach effectively isolates the new data from the cache management system 100's ongoing cleanup operation.

In a second solution, the new data is allocated into a new cache line within the cache memory 20, but the controller 10 immediately forces the metadata of this new line into a non-discardable state. For example, the controller 10 may set its non-discardable bit to “1” (in the 1-bit embodiment) or set its CMO-bits to state “0b10” (in the 2-bit embodiment). The second solution approach is advantageous because the new data can still benefit from cache residency, while being fully protected from accidental discard.

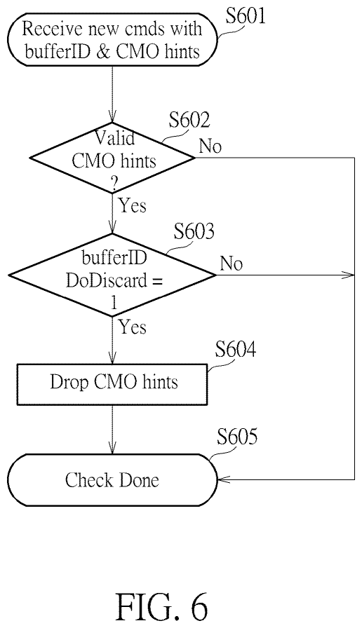

FIG. 6 to FIG. 10 are flowcharts illustrating sanity check protection mechanisms of the cache management system 100 in FIG. 1. FIG. 6 is a flowchart illustrating a first embodiment of the protection mechanism, which is triggered when the controller 10 receives a new command with CMO hints while a deferred discard operation is already in progress for the associated Buffer ID. This mechanism ensures data integrity by preventing new, valid data from being unintentionally discarded.

The process initiates at step S601, where the controller 10 receives one or more new commands, each associated with a specific Buffer ID and including corresponding CMO hints. Subsequently, at step S602, the controller 10 evaluates whether the received CMO hints are valid. If the hints are determined to be invalid (the “No” branch from S602), the hints are disregarded, and the process concludes at step S605.

If the hints are valid (the “Yes” branch from S602), the process proceeds to the core sanity check at step S603. At step S603, the controller 10 checks the status of the Buffer ID associated with the incoming command to determine if a “Buffer-discard” operation is currently active for that Buffer ID (i.e., if the “Do Discard” flag is set to “1”). If no discard operation is active (the “No” branch from S603), it implies there is no immediate risk of data corruption for this new command, and the check concludes at step S605.

However, if a “Buffer-discard” is currently in progress for the Buffer ID (the “Yes” branch from S603), the protected condition is met, and the controller 10 proceeds to take protective action at step S604. At step S604, to prevent the data associated with the incoming command from being unintentionally discarded, the controller 10 applies a protection measure by dropping or ignoring the newly received CMO hints. Then, the protection check process is completed at step S605.

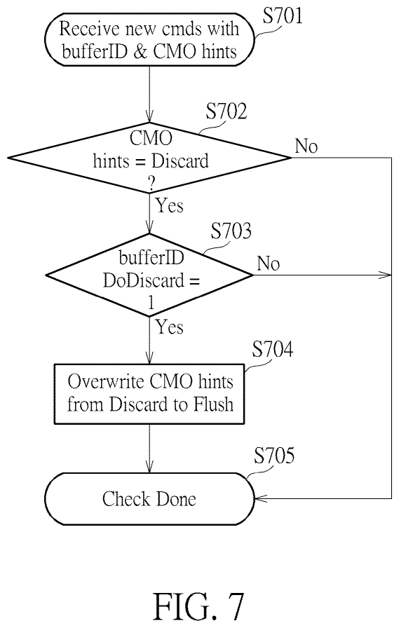

FIG. 7 is a flowchart illustrating a second embodiment of the protection mechanism, which applies a different protective measure compared to the embodiment shown in FIG. 6. This approach is also triggered when the controller 10 receives new commands during an active deferred discard operation, but instead of dropping the hint, the controller 10 converts the hint to a safer operational state.

The process initiates at step S701, where the controller 10 receives one or more new commands, each associated with a specific Buffer ID and including corresponding CMO hints. At step S702, the controller 10 evaluates the type of the incoming CMO hints to determine if they constitute a “Discard Request”. If the CMO hint is not a “Discard Request” (the “No” branch from S702), this specific protection mechanism does not apply, and the check concludes at step S705.

If the CMO hint is a “Discard Request” (the “Yes” branch from S702), the process proceeds to the sanity check at step S703. At step S703, the controller 10 determines if a “Buffer-discard” operation is currently in progress for the Buffer ID associated with the new command (i.e., if the “Do Discard” flag is set to “1”). If no discard operation is active for the Buffer ID (the “No” branch from S703), the new “Discard Request” is considered safe to process, and the check concludes at step S705.

However, if the protected condition is met, meaning a new “Discard Request” has been received for a Buffer ID that is already being discarded (the “Yes” branch from S703), the controller 10 executes the protective action at step S704. At step S704, the controller 10 overwrites or downgrades the CMO hint, converting it from a “Discard Request” to a “Flush Request”. This action ensures that the data associated with the new command will be safely written back, thereby preventing data loss, while still honoring the user's general intent to perform a cache maintenance operation. After the hint is converted, the protection check process is completed at step S705.

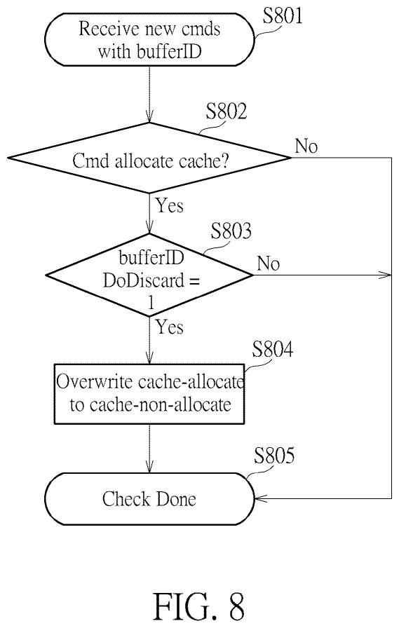

FIG. 8 is a flowchart illustrating a third embodiment of the protection mechanism. The process initiates at step S801, where the controller 10 receives one or more new commands, each associated with a specific Buffer ID and including corresponding CMO hints. At step S802, the controller 10 evaluates whether an incoming command requires a new cache line to be allocated. If the command does not require allocation, for example in the case of a cache hit, the protection mechanism is not needed, and the process concludes at step S805.

However, if the command does require a cache line to be allocated (the “Yes” branch from S802), the process proceeds to the sanity check at step S803. At step S803, the controller 10 performs the core sanity check by determining if a “Buffer-discard” operation is currently active for the associated Buffer ID (i.e., if the “Do Discard” flag is set to “1”). If no discard operation is in progress (the “No” branch from S803), the allocation request is deemed safe, and the process concludes at step S805, allowing the allocation to proceed normally.

Conversely, if the protected condition is met, where an allocation is requested for a Buffer ID that is actively being discarded (the “Yes” branch from S803), the controller 10 executes the protective measure at step S804. At step S804, the controller 10 overrides the original request and forces the operation to become “cache-non-allocate”. This action prevents the new data from being written into the cache memory, thereby protecting it from the ongoing discard process. For instance, the data may be written directly to a downstream memory component instead. Following this override, the protection check process is completed at step S805.

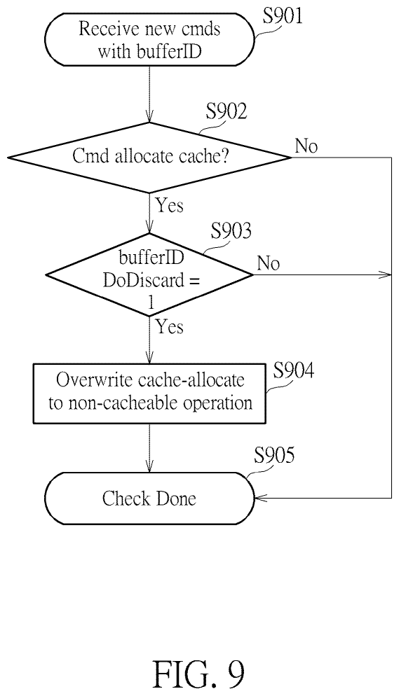

FIG. 9 is a flowchart illustrating a fourth embodiment of the protection mechanism, presenting a variation of the allocation control mechanism shown in FIG. 8. This approach is also triggered by a command requiring cache allocation for a Buffer ID that is concurrently undergoing a deferred discard operation.

The process initiates at step S901, where the controller 10 receives one or more new commands, each associated with a specific Buffer ID and including corresponding CMO hints. At step S902, the controller 10 determines if a command requires a new cache line to be allocated. If allocation is not required, the process concludes at step S905.

If allocation is required (the “Yes” branch from S902), the controller 10 proceeds to the sanity check at step S903, where it determines if a “Buffer-discard” operation is active for the associated Buffer ID. If the operation is not active (the “No” branch from S903), the allocation request is considered safe, and the check concludes at step S905.

However, if the protected condition is met (the “Yes” branch from S903), the controller 10 executes the protective measure at step S904. At step S904, the controller 10 modifies the attribute by overwriting the cache-allocate request to a “non-cacheable operation”. Similar to the “non-allocate” action in FIG. 8, this ensures the new data is not stored in the cache memory, thus preventing it from being affected by the ongoing discard process. Following this modification, the protection check process is completed at step S905.

The terms “cache-non-allocate” mentioned in step S804 and “non-cacheable operation” mentioned in step S904 both describe protective measures designed to prevent new data from being written into the cache memory during a protected condition, although they can represent different implementation-level details. Specifically, a “cache-non-allocate” policy, as referenced in FIG. 8, refers to a decision made by the cache controller in response to a specific command that misses in the cache. For example, under a “write-no-allocate” policy, a write command that misses is sent directly to a downstream memory component without allocating a new cache line for that data in the cache. In contrast, a “non-cacheable operation”, as referenced in FIG. 9, implies that the transaction itself is flagged with an attribute indicating that the data it carries must bypass the cache entirely, regardless of a hit or miss. Therefore, the distinction can lie in the mechanism's scope: “non-allocate” is often a cache policy applied at the moment of a miss for an otherwise cacheable transaction, whereas “non-cacheable” can be an inherent attribute of the operation that dictates it should never be serviced by the cache in the first place.

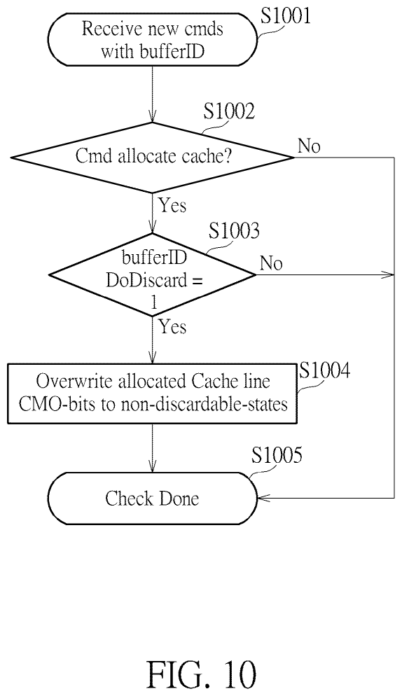

FIG. 10 is a flowchart illustrating a fifth embodiment of the protection mechanism, which presents an alternative to the allocation-control methods of FIG. 8 and FIG. 9. In this approach, the new data is permitted to be allocated into the cache, but its metadata is immediately modified to ensure its safety from any ongoing discard operations.

The process is initiated at step S1001 upon the controller 10 receiving new commands with an associated Buffer ID. At step S1002, the controller 10 determines if a command requires a new cache line to be allocated; if allocation is not required, the process concludes at step S1005. If allocation is required (the “Yes” branch from S1002), the controller 10 proceeds to the sanity check at step S1003. At step S1003, the controller 10 checks if a “Buffer-discard” operation is currently active for the Buffer ID. If the operation is not active (the “No” branch from S1003), the allocation is deemed safe, and the check concludes at step S1005.

However, if the protected condition is met (the “Yes” branch from S1003), where an allocation is requested for a Buffer ID that is undergoing a discard process, the controller 10 executes the protective measure at step S1004. At step S1004, the controller 10 allows the new data to be allocated into a new cache line but immediately overwrites the metadata of that newly allocated line, specifically setting its “CMO-bits” to a “non-discardable-state”. This action ensures that while the new data can benefit from cache residency, it is protected from being erroneously removed by the ongoing discard operation. For instance, its state could be set to “0b10” (“Deferred, Flush-only”). The protection check process is then completed at step S1005.

The aforementioned embodiments illustrate details of how a deferred CMO hint and its associated Buffer ID is stored in the metadata of a cache line, for instance, using a 2-bit CMO-bits field or a single non-discardable bit. Furthermore, protection mechanisms have been described to ensure data integrity during the deferred CMO process. The following embodiments describe a mechanism for executing the deferred CMOs that are stored across the cache memory 20. A first embodiment for performing the deferred CMOs is through an active background traversal process, which is implemented by a hardware-based Garbage Collection (GC) engine, for example, within the controller 10.

The GC engine is configured to periodically and automatically scan the cache memory 20 to identify and process cache lines with active deferred CMOs. The GC engine scanning mechanism provides a “fire-and-forget” functionality that is transparent to the upstream user, who does not need to poll for the completion of the cleanup task. Detailed operations of the GC engine are illustrated below.

To implement the GC engine, the cache management system 100 utilizes specific data structures for storing information about various deferrable operations. The GC engine provides a general framework to periodically scan the cache and perform triggered, dataset-based operations, which can include not only Cache Maintenance Operations (CMOs) but also other tasks such as data compression or priority management. Table T8 and Table T9 illustrate exemplary data structures for this mechanism.

TABLE T8

| | Cache | | | | | | |
|---|---|---|---|---|---|---|---|
| Tag | Status | LRU- | Buffer | Evict- | | Priority | |
| Address | (MOESI) | bit(s) | ID | first | Parity | Offset | Op Code |
| 0xdeadbeef | Valid | 1 | GPU | 1 | xx | −1 | Do |
| | | | | | | | Compress |

Table T8 shows an exemplary structure of the metadata that can be stored for each cache line within the cache memory 20. This structure is designed to support a variety of deferrable operations. For example, an OP Code field used to store a hint for the specific deferred operation intended for this cache line. For example, the Op Code can be set to “Do Compress” to mark the line for a future compression operation. A user may trigger this after the data is no longer frequently accessed to reduce write-back bandwidth to DRAM. In other cases, this field can store a deferred CMO hint, such as a discard hint. A Priority Offset field can be used to implement another type of deferrable operation, such as allowing a user to trigger a priority adjustment for all cache lines belonging to a specific Buffer ID.

TABLE T9

| Buffer ID | Pending LRU Op | Pending Priority Op | Pending Op Code |
|---|---|---|---|
| GPU | Set MAX | N/A | N/A |
| NPU | Set 0 | N/A | N/A |
| CPU | N/A | Set −1 | N/A |

Table T9 shows an exemplary structure of the status table that is monitored by the GC engine. Table T9 is configured to store all pending high-level, dataset-based requests that have been issued by upstream users. The columns represent different categories of pending operations that can be triggered on a per-Buffer ID basis.

When a user wishes to trigger a deferred operation for an entire dataset, a corresponding flag is set in this table. For example, to trigger a priority change for the “CPU” Buffer ID, its Pending Priority Op entry is set to Set −1. Similarly, to trigger a “Buffer-discard”, the Pending Op Code entry for the target Buffer ID would be set to indicate a discard operation is pending. The GC engine detects these pending commands in the status table and then initiates the cache traversal process to perform the corresponding actions based on the Op Code stored in each cache line.

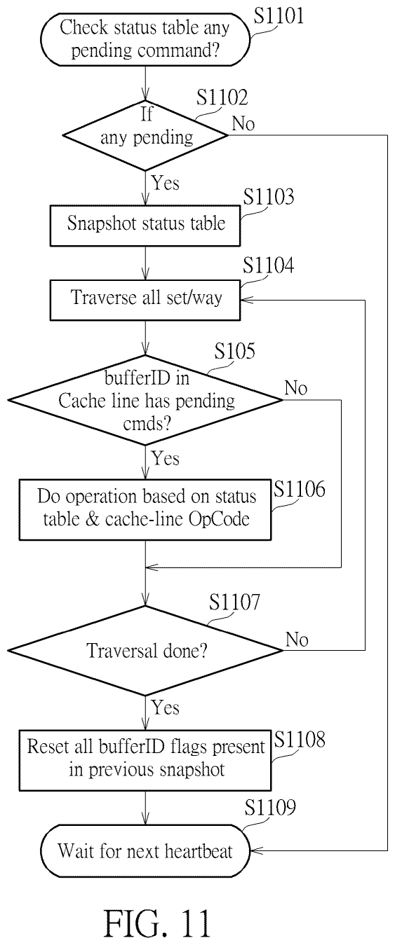

FIG. 11 is a flowchart illustrating a method performed by the hardware-based Garbage Collection (GC) engine to execute pending deferred CMOs of the cache management system 100. The GC engine provides an automated and user-transparent mechanism for cache cleanup.

The process begins at step S1101, where the GC engine periodically, such as upon a regular “heartbeat” signal, checks the status table to determine if any pending commands exist. At decision step S1102, if no pending commands are found (the “No” branch), the GC engine enters an idle state at step S1109 and waits for the next heartbeat to repeat the check.

If one or more pending commands are detected in the status table (the “Yes” branch from S1102), the process proceeds to step S1103. Step S1103 is important for the “fire-and-forget” functionality. The GC engine takes a snapshot of the entire status table, saving the state of all trigger flags (e.g., Do Flush, Do Discard) for all Buffer IDs at that specific moment. The snapshot can be regarded as a record of the operations to be fully completed in the current GC cycle. After taking the snapshot, the GC engine at step S1104 begins a full traversal of the cache memory 20, systematically scanning all cache sets and ways.

During the traversal, for each cache line encountered, the process moves to step S1105. The engine checks if the Buffer ID of the current cache line has a corresponding pending command in the current status table (not the snapshot). Step S1105 allows new commands that arrive mid-traversal to be acted upon immediately. If a pending command exists (the “Yes” branch from S1105), the process proceeds to step S1106, where the controller 10 performs the appropriate operation on the cache line's metadata. The specific action is based on the trigger command in the status table and the deferred CMO hint (or Op Code) stored in the cache line itself. The process then continues, looping through all cache lines until the traversal is complete, as determined at step S1107.

Once the entire traversal is finished (the “Yes” branch from S1107), the process proceeds to step S1108. At this step, the controller 10 updates the status table based on the previous snapshot taken at step S1103. Specifically, it clears only those trigger flags that were set in the snapshot. Any new trigger command that was issued during the traversal will not have been in the snapshot, and its flag will therefore remain set in the status table. This approach ensures that partially completed operations for new commands will be fully processed in the “next GC cycle”. The snapshot-based update mechanism makes the entire process transparent to the user. Finally, the current GC cycle concludes, and the process moves to step S1109 to await the next heartbeat.

To further illustrate the snapshot mechanism and the user-transparent update process shown in steps S1103 and S1108 of FIG. 11, a specific operational example is provided with reference to Table T10 and Table T11 below.

TABLE T10

| Snapshot (Buffer ID) | Discard | Flush |
|---|---|---|
| B0 | 1 | 0 |
| B1 | 1 | 0 |
| B2 | 0 | 0 |

Table T10 represents the state of the status table at the beginning of a GC cycle, when the snapshot is taken at step S1103. In this example, “Buffer-discard” trigger commands are active for Buffer ID “B0” and Buffer ID “B1”. No trigger command is active for Buffer ID “B2” at this time. The snapshot records that the operations for “B0” and “B1” are the designated tasks to be completed in this cycle. As the GC engine proceeds with its traversal of the cache memory 20 (steps S1104-S1107), the following new events occur in this example.

Event 1: A new “Buffer-discard” trigger command is issued for Buffer ID “B2”.

Event 2: A corner case event occurs for Buffer ID “B1”. An upstream user, without waiting for the original discard operation to finish, reuses Buffer ID “B1”, performs new tasks, and then issues a new “Buffer-flush” trigger command for “B1”.

TABLE T11

| After B0/B1 done | Discard | Flush |
|---|---|---|
| B0 | 1→0 | 0 |
| B1 | 1→0 | 1 |
| B2 | 1 | 0 |

After the update logic of step S1108 is applied at the end of the traversal. The controller 10 compares the current status against the snapshot taken in Table T10 to determine which flags to clear. For example, for Buffer ID “B0”, the Discard flag was “1” in the snapshot and no new command was received. Therefore, the operation is considered complete, and its Discard flag is cleared from “1” to “0”. For Buffer ID “B2”, a new Discard command arrived during the traversal. Because this command was not in the original snapshot, its Discard flag is not cleared and remains “1”. This ensures that the command for “B2” will be fully processed in the next GC cycle. For Buffer ID “B1”, the original Discard command was in the snapshot, so it is cleared from “1” to “0”. However, the new flush command arrived mid-cycle and was not in the snapshot. Therefore, its Flush flag remains set to “1”.

This embodiment demonstrates how the snapshot-based update mechanism correctly handles new commands that arrive mid-cycle. The snapshot-based update mechanism ensures that only the initially requested operations are marked as complete, while any new requests remain pending for the next cycle. As a result, it guarantees the completeness of all operations and makes the entire process transparent to the user, who can issue new commands at any time without needing to poll for the completion of previous ones.

As illustrated in the implementation examples for both the 2-bit and 1-bit CMO hints in cache line embodiments, the GC engine, which is part of the controller 10, is configured to periodically monitor the Buffer ID attribute and status table (exemplified by Table T7). When the GC engine detects an active trigger command, such as a “Do Flush” or “Do Discard” flag set to “1”, it initiates a traversal process to scan the cache memory 20. During the scan, the GC engine reads the metadata of each cache line, which is structured as shown in tables previously mentioned (e.g., Table T6), and applies the corresponding processing logic to execute the pending deferred operations.

It should be understood that the deferred CMO of the embodiments permits a more flexible and efficient approach to execution. One embodiment of the flexible approach involves utilizing a single Evict-first bit in the metadata of each cache line to mark that the data should be prioritized for eviction. Instead of immediately invalidating a cache line when processing its pending deferred CMO, the controller 10 can simply set the line's Evict-first bit to “1”. This action can be regarded as a hint to the cache's replacement policy. Subsequently, when a new allocation request requires space in the cache, the replacement policy will preferentially select cache lines with the Evict-first hint as victims for eviction. The Evict-first mechanism thereby achieves the goal of making room for other data without causing an immediate performance stall, as the physical eviction and any associated write-back traffic are spread out over time. The Evict-first mechanism is integral to the process performed by the GC engine. When the GC engine traverses the cache memory to execute deferred CMOs, it applies the following logic. For any pending flush-type or discard-type CMO, the controller 10 sets the Evict-first bit of the corresponding cache line. The controller 10 performs a flush-type operation on a cache line if it is marked as non-discardable. When executing a flush, it also ensures the line is marked as non-discardable (e.g., by setting a flag or updating its state) to prevent it from being discarded in the future. When executing a discard-type CMO on a line that is discardable (e.g., its non-discardable bit is “0”), the controller 10 sets the line's dirty bit to “0” to prevent a write-back upon eviction.

The advantage of the GC engine embodiment is that its operation is designed to be “transparent” to the upstream software (SW) or user. This is also referred to as a “fire-and-forget” mechanism, which simplifies the software's responsibility for cache management. From the user's perspective, “transparency” means that once a trigger command to execute a deferred CMO for a specific Buffer ID is issued, the user can consider the task handed off and the Buffer ID obsolete for that previous job. The user is not required to poll a status register to check for completion, and the controller 10 or GC engine will not send any feedback signal (such as an interrupt) after the operation ends. The user can proceed with other tasks immediately. The user-transparent behavior is enabled by the snapshot-based update process of the GC engine. As described in the flowchart of FIG. 11, the mechanism performs the following steps. First, the GC engine takes a snapshot of the status table to record which Buffer IDs have active trigger commands at the beginning of the traversal cycle. After the cache traversal is complete, the GC engine automatically resets the trigger flags in the status table for those Buffer IDs that were recorded in the snapshot. A specific implementation of this reset logic can be a bitwise operation, such as Status-table [n:0] &=˜Snapshot [n:0], which clears the bits that were set in the snapshot. By automatically managing the lifecycle of the trigger commands, this mechanism relieves the user from the burden of tracking the cleanup process, thereby simplifying software design and improving overall system efficiency.

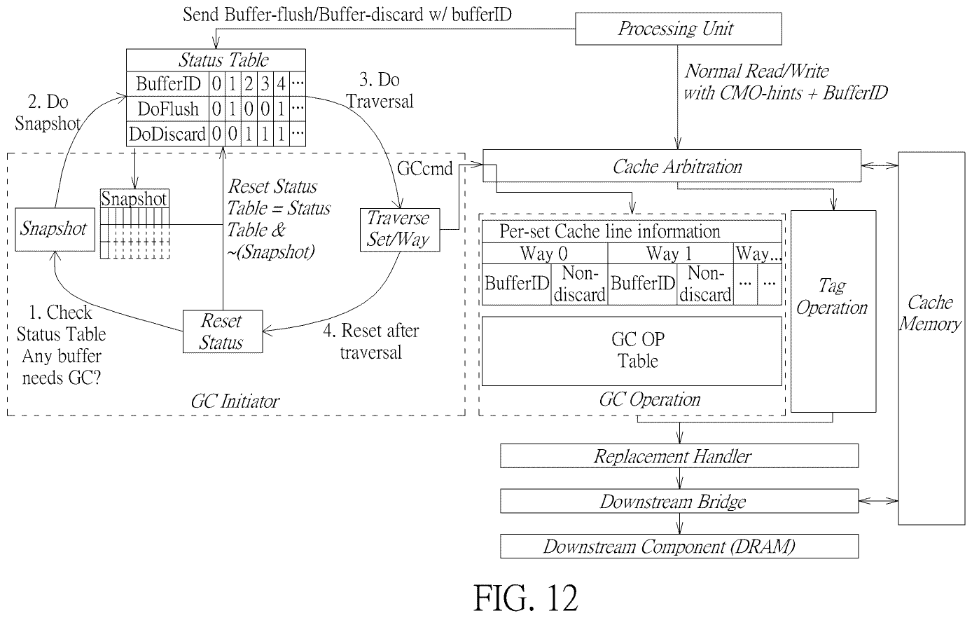

FIG. 12 is a detailed data flow diagram illustrating a working example of the GC engine executing a deferred “Buffer-discard” operation of the cache management system 100. The diagram shows the comprehensive data and control flow, from the initial user command that records a deferred hint, to the high-level trigger that initiates the background cleanup process, and finally to the automated reset that makes the mechanism transparent to the user.

The process involves an upstream user, such as a processing unit (e.g., GPU), which interacts with the system in two distinct phases. First, during a job's execution, the processing unit issues normal read and write commands that are accompanied by CMO hints and a Buffer ID. The system can record the intended future operations (e.g., flush or discard) in the metadata of the corresponding cache lines as they are being allocated. Second, once the user determines that a dataset is no longer needed (e.g., after a job is complete), it issues a high-level trigger command, such as a “Buffer-discard” for a specific Buffer ID. The trigger command does not operate on a specific address but instead modifies flags (e.g., setting the “Do Discard” flag to “1”) in a status table, signaling the intent to perform the previously recorded operations for the entire dataset.

Specifically, the GC initiator periodically monitors the status table (step 1, “Check Status Table”) to detect if any “Do Flush” or “Do Discard” flag has become active. Upon detecting an active request, the GC cycle is initiated. As its first action (step 2, “Do Snapshot”), the controller 10 captures a complete snapshot of the status table's current state. The snapshot is important as it decouples the long-running traversal process from the user's ability to issue new commands, thereby preventing race conditions where a new, unrelated command might be incorrectly cleared upon completion of the current cycle.

With the snapshot taken, the GC initiator directs the GC operation engine to begin step 3, “Do Traversal”. The GC operation engine systematically scans the entire cache memory. For each cache line, it reads the line's metadata (“per-set cache line information”), which includes its Buffer ID and its “Non-discard” state bit. It uses the Buffer ID to look up the corresponding trigger command flags (“Do Flush” and “Do Discard”) from the live status table. The set of inputs is fed into the “GC OP Table”, which contains the processing logic. The GC OP Table with 1-bit CMO hints can be expressed as Table GCOP1. The GC OP Table with 2-bit CMO hints can be expressed as Table GCOP2.

TABLE GCOP1
GC OP Table

| Input | | | Output to Metadata | | |
|---|---|---|---|---|---|
| From status table | | From cache | | Evict | |
| Do Discard | Do Flush | Non-discard | Dirty | First | Non-discard |
| 0 | 0 | x | Keep | Keep | Keep |
| x | 1 | x | Keep | Set 1 | Set 1 |
| 1 | 0 | 0 | Set 0 | Set 1 | Keep |
| 1 | 0 | 1 | Keep | Set 1 | Keep |

Table GCOP1 illustration details the processing logic of the GC operation engine when operating under the 1-bit CMO hint embodiment. Table GCOP1 dictates how the controller 10 modifies a cache line's tag metadata based on a combination of trigger commands from the Status Table (specifically, the “Do Flush” and “Do Discard” flags) and the cache line's intrinsic state (specifically, its “Non-discard” bit). The logic defined in the table addresses four primary operational cases.

The first row of Table GCOP1 corresponds to an Idle State. This case occurs when both the “Do Flush” and “Do Discard” flags for the associated Buffer ID are inactive (i.e., set to ‘0’). In this state, there are no pending operations to execute. Consequently, the controller 10 makes no changes to the cache line's metadata. The “Dirty” bit, the “Evict First” bit, and the “Non-discard” bit are all kept in their current state.

The second row of Table GCOP1 defines the behavior for a Buffer-flush Command. This case is triggered when the “Do Flush” flag is active (set to ‘1’). This command executes a safe, unconditional flush. To achieve this, the controller 10 keeps the “Dirty” bit to ensure that if the data is dirty, it will be written back to a downstream memory. Simultaneously, it sets the “Evict First” bit to ‘1’ to signal the replacement policy to prioritize this line for eviction. Crucially, it also forces the output “Non-discard” bit to ‘1’, permanently marking the line as non-discardable to guarantee its integrity against any subsequent, more aggressive discard commands.

The third row of Table GCOP1 addresses the primary Buffer-discard Scenario. This case applies when a “Buffer-discard” command is active (“Do Discard” is ‘1’) and the cache line is discardable (its “Non-discard” bit is ‘0’). Here, the controller 10 performs the core discard action by setting the “Dirty” bit to ‘0’, which prevents a write-back of the line's data upon eviction. The “Evict First” bit is also set to ‘1’ to ensure the cache line is promptly made available for new data. The “Non-discard” state is kept as is.

The fourth row of Table GCOP1 describes the protective behavior for a Buffer-discard Command on a Non-discardable Line. This case is triggered when a “Buffer-discard” command is active (“Do Discard” is ‘1’), but the cache line's own “Non-discard” bit is already set to ‘1’, indicating it has been previously marked as requiring a safe write-back. In this scenario, the controller 10 honors the protective “Non-discard” state. It keeps the “Dirty” bit unchanged, thereby preventing the data from being discarded and effectively downgrading the operation to a flush. It still sets the “Evict First” bit to ‘1’ to mark the line for a safe eviction. The “Non-discard” state is maintained as ‘1’.

TABLE GCOP2
GC OP Table

| Input | | | Output to Metadata | | |
|---|---|---|---|---|---|
| From status table | | From cache | | Evict | |
| Do Discard | Do Flush | Non-discard | Dirty | First | Non-discard |
| 0 | 0 | x | Keep | Keep | Keep |
| x | 1 | 0b1x | Keep | Set 1 | Set 0b10 |
| 1 | 0 | 0b11 | Set 0 | Set 1 | Keep |
| 1 | 0 | 0b10 | Keep | Set 1 | Keep |

Table GCOP2 illustration details the processing logic of the GC operation engine when operating under the 2-bit CMO hint embodiment. In a first case, when both the “Do Flush” and “Do Discard” flags are inactive (‘0’), no operations are pending, and the controller 10 makes no modifications to the cache line's “Dirty”, “Evict First”, or “Non-discard” metadata. When a “Buffer-flush” command is active (“Do Flush” is ‘1’), the system performs a safe flush on any line in a pending deferrable state (i.e., input state “0b1x”). In this scenario, the controller 10 keeps the “Dirty” bit for a potential write-back, sets the “Evict First” bit to ‘1’, and forces the output “Non-discard” state to “0b10” (“Deferred, Flush-only”), thereby downgrading any cache line previously marked as discardable to a safer, flush-only state. In the event of a “Buffer-discard” command (“Do Discard” is ‘1’), the action is contingent on the specific 2-bit state. If the cache line is in the “Deferred, Allow Discard” state (“0b11”), the controller 10 performs the discard by setting the “Dirty” bit to ‘0’ and setting the “Evict First” bit to ‘1’. However, if the cache line is already in the more protective “Deferred, Flush-only” state (“0b10”), the controller 10 honors this state by keeping the “Dirty” bit unchanged and only setting the “Evict First” bit to ‘1’, treating the discard command as a flush for that specific line.

Upon completion of the full traversal, the controller 10 performs the final cleanup as step 4, “Do Reset after traversal”. It uses the previously captured snapshot to identify exactly which trigger flags were active at the start of this specific cycle. It then clears only those specific flags in the live status table, for example, via a bitwise operation (Status Table &=˜ Snapshot). The precise, snapshot-based reset is the key to the “fire-and-forget” nature of the mechanism. It ensures that only fully completed requests are cleared, while any new requests that arrived mid-cycle remain pending. By using this mechanism, the processing unit can reuse Buffer IDs at any time without needing to poll for the completion of the background cleanup, thus making the entire process robust and transparent.

The aforementioned embodiments illustrate the execution of the deferred CMOs, wherein an active, hardware-based Garbage Collection (GC) engine periodically traverses the cache memory to process pending operations. While the GC engine provides a robust solution, a condition may arise where a cache line with a pending deferred CMO is selected as a victim for eviction by the replacement policy before the GC engine has had a chance to process that particular cache line. In such a scenario, the pending deferred CMO hint could be lost when the cache line is evicted, preventing the intended operation from being performed.

To address this condition and provide a more comprehensive solution, a second embodiment for executing deferred CMOs is disclosed. The mechanism may be implemented as an alternative, or as a complementary “remedy” or “workaround” to the GC engine. The second embodiment is a passive “Execution on Eviction” mechanism. In contrast to the proactive scanning of the GC engine, the Execution on Eviction mechanism integrates the check for deferred CMOs directly into the cache's standard eviction pathway. The detailed operation of this passive mechanism is illustrated later.

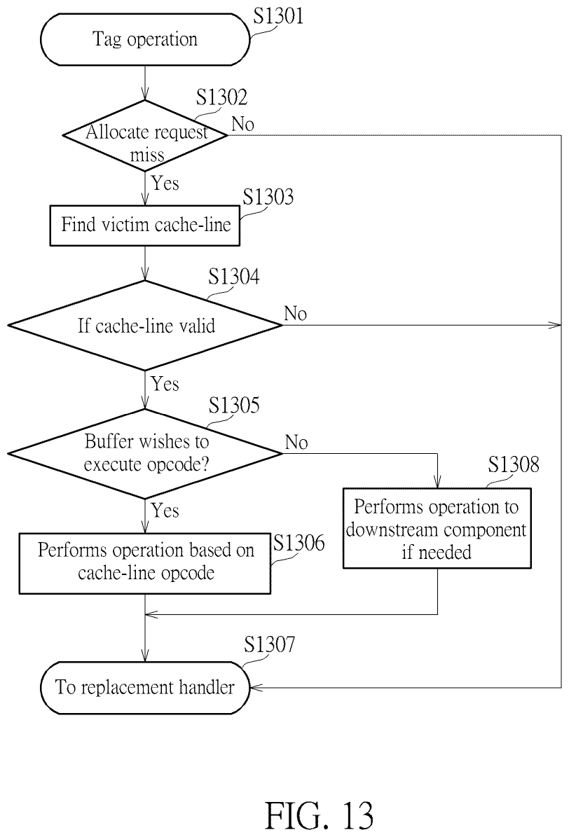

FIG. 13 is a flowchart illustrating a process of the execution on eviction mechanism performed by the cache management system 100. An alternative or complementary embodiment for executing deferred CMOs is a passive “Execution on Eviction” mechanism. Instead of proactively scanning the cache, this mechanism integrates the check for pending CMOs into the standard eviction pathway of the cache memory. The passive “Execution on Eviction” mechanism utilizes the exemplary data structures shown in Tables T12, T13, and T14.

TABLE T12

| Buffer ID | Do Flush | Do Discard |
|---|---|---|
| CPU | 0 | 0 |
| GPU_0 | 0 | 1 |
| GPU_1 | 0 | 0 |
| GPU_2 | 0 | 0 |

TABLE T13

| CMO Bits | Description |
|---|---|
| 0b00 | Disallow CMO |
| 0b01 | Allow CMO, but no CMO is required |
| 0b10 | Require Write back + Do invalidate |
| 0b11 | Do invalidate without write-back |

TABLE T14

| | Way 0 | Way 1 | Way 2 | Way 3 |
|---|---|---|---|---|
| | BID/Op Code | BID/Op Code | BID/Op Code | BID/Op Code |
| Set0 | CPU/00 | GPU_0/11 | GPU_1/10 | GPU_2/01 |
| Set1 | CPU/00 | GPU_0/11 | GPU_1/10 | GPU_2/01 |
| Set2 | CPU/00 | GPU_1/11 | GPU_1/01 | GPU_2/01 |
| Set3 | CPU/00 | GPU_1/11 | GPU_2/01 | GPU_2/01 |

Table T12 is an exemplary status table, maintained by the controller 10, used to control the passive “Execution on Eviction” mechanism. Structurally and functionally, Table T12 is analogous to the Status Table used by the active GC engine, as it contains per-Buffer ID flags for “Do Flush” and “Do Discard” to specify a pending cache maintenance operation. However, unlike the table for the GC engine which is periodically polled to initiate a full cache traversal, Table T12 is consulted only when a specific cache line has already been selected as a victim for eviction. Table T13 defines the statuses of a 2-bit “CMO Bits” field, which is stored in the metadata of each individual cache line to represent its specific deferred CMO state. This state is consulted during an “Execution on Eviction” event to determine the appropriate action to be performed on the victim cache line. As shown in the table, the state “0b00” indicates that deferred CMO is disallowed for the cache line. The state “0b01” is a neutral state, signifying that while deferred CMO is permitted, no specific operation is currently pending for the line. A state of “0b10” indicates a pending deferred flush, as it requires a write-back of dirty data before the line is invalidated. Finally, a state of “0b11” indicates a pending deferred discard, where the line can be invalidated without a write-back.

In FIG. 13, the process of the Execution on Eviction mechanism begins at step S1301 during a tag operation. The mechanism is triggered at step S1302 when an allocation request for new data misses in the cache, which necessitates the eviction of an existing cache line. At step S1303, the cache's replacement policy finds a victim cache line to evict.

At step S1304, the controller 10 can check if the victim cache line contains valid data. If the cache line is not valid, it can be overwritten without further action. If the line is valid (the “Yes” branch from S1304), the process proceeds to the core decision at step S1305. Here, the controller 10 can check if the operation is allowed to be executed for the victim line's Buffer ID. It reads the Buffer ID from the victim line (e.g., “GPU_0” from Set0/Way1 in Table T14) and looks up its status in the Allow Execute Op Code table (Table T12).

If execution is allowed (the “Yes” branch from S1305, as is the case for “GPU_0” which is set to “Do Discard=1” in Table T12), the process moves to step S1306. The controller 10 reads the Op Code from the victim line's metadata (e.g., “11” for Set0/Way1 in Table T14) and, based on the definition in Table T13, performs the corresponding operation. For example, for an Op Code of “11”, the controller 10 executes a discard by clearing the line's dirty bit before it is overwritten. The process then proceeds to the replacement handler at step S1307.

If execution is not currently allowed for the victim line's Buffer ID (the “No” branch from S1305, as would be the case for “GPU_1” which is set to “Do Discard & Do Flush=0” in Table T12), the process moves to step S1308. In this case, to prevent the deferred CMO hint from being lost, the controller 10 has the option to propagate the hint (Op Code) and its Buffer ID to the downstream memory component as part of the write-back data. The propagated hint can then be stored in the metadata of the corresponding data entry in the downstream memory. It should be understood that the benefit of propagating the deferred CMO hint is to preserve the opportunity for a cache-efficiency optimization at a lower level in the memory hierarchy. Without propagation, once the cache line is evicted from the current cache, its deferred status (e.g., that the data is discardable) would be lost. Consequently, any downstream memory component would be forced to treat the data conservatively, for instance by performing a full write-back for dirty data. However, by propagating the hint, for example, from a Level 2 (L2) cache to a Level 3 (L3) cache in a multi-level cache system, the L3 cache inherits the knowledge that the data may be discardable. The L3 cache can then perform the discard operation at a later time when the appropriate trigger conditions are met for that level, thus extending the power and bandwidth-saving benefits of the deferred CMO mechanism across the memory hierarchy. The process then continues to the replacement handler at step S1307.

The Execution on Eviction mechanism in FIG. 13 offers several advantages. A main benefit of this passive approach is its efficiency in terms of power and performance. In contrast to the active GC engine that must periodically traverse the entire cache memory, the Execution on Eviction mechanism incurs no overhead associated with a full scan, as it is only activated when an eviction is already taking place. This makes the mechanism simpler and more power-efficient. Furthermore, the Execution on Eviction mechanism ensures that if a cache line with a pending deferred CMO is selected as a victim before the GC engine can process it, the pending operation is still handled at the moment of eviction instead of being lost. Therefore, the Execution on Eviction mechanism makes the overall deferred CMO system more robust and comprehensive.

In summary, the various embodiments described above illustrate a cache management system and its method of operation. The method provides a fundamental departure from traditional approaches by storing a deferred CMO hint and a dataset identifier (Buffer ID) into the metadata of each cache line. Subsequently, upon receiving a single, high-level trigger command associated with the dataset identifier, the controller efficiently performs the pending deferred CMOs on all corresponding cache lines within the cache memory.

The dataset-based, deferred CMO mechanism overcomes the significant disadvantages of prior art. It eliminates the need for a user to issue a massive number of address-based commands to traverse an entire data footprint, thus providing a significant improvement in efficiency and power consumption. Furthermore, it relieves the user from the impractical burden of tracking specific memory addresses, allowing for a simple and intuitive cleanup operation (e.g., “Buffer-discard”) after a job is complete.

The advantages of the embodiments are further enhanced by its flexibility and robustness. The cache management system can support various operational modes (e.g., “Flush-only”, “Flush-or-Discard”) and trigger granularities (Buffer-based or Job-based) to suit different application needs. The Evict-first mechanism ensures smooth execution without performance stalls, while the snapshot-based GC engine provides a user-transparent, “fire-and-forget” experience. The passive “Execution on Eviction” mechanism provides a complementary safety net, and the race condition protection features guarantee data integrity even when Buffer IDs are reused. As a result, these features of the cache management system provide a more advanced, efficient, and significantly safer solution for cache management compared to conventional methods.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing a cache memory, comprising:
associating a dataset with a cache maintenance operation (CMO) mode, wherein the CMO mode is a deferred mode;
storing a deferred CMO hint in a metadata portion of a cache line within the cache memory;
storing a dataset identifier in the metadata portion of the cache line to associate the cache line with the dataset;
receiving a trigger command associated with the dataset identifier; and
performing the deferred CMO on one or more cache lines in the cache memory associated with the dataset identifier based on the trigger command.

2. The method of claim 1, wherein the deferred mode is selected for the dataset from a plurality of available CMO modes, the plurality of modes further comprising an immediate mode, and wherein an immediate CMO is performed when the dataset is associated with the immediate mode.

3. The method of claim 1, wherein the deferred CMO hint is represented by two bits stored for the cache line, and the two bits defining a state machine for the cache line comprise at least: a flush pending state wherein the deferred CMO is pending and requires a flush with write-back, and a discard pending state wherein the deferred CMO is pending and is discardable without write-back.

4. The method of claim 1, wherein the deferred CMO hint is represented by a single bit stored for the cache line, and the single bit indicates a first state when a first value is set and a second state when a second value is set, the first state allows a deferred discard operation on the cache line, and a second state disallows the deferred discard operation or forces a deferred flush operation on the cache line.

5. The method of claim 1, wherein the deferred CMO hint indicates whether the cache line is discardable without write-back or requires a flush with write-back, and performing the deferred CMO comprises:
selectively clearing a dirty bit of the cache line if the deferred CMO hint indicates the cache line is discardable.

6. The method of claim 5, wherein after selectively clearing the dirty bit, the cache line is transitioned to a clean state without being written back to a further memory component.

7. The method of claim 5, further comprising:
in response to the deferred CMO hint indicating the cache line requires a flush with write-back, initiating the write-back of the cache line.

8. The method of claim 1, wherein performing the deferred CMO comprises:
setting an evict-first indicator in the metadata portion of the one or more cache lines;
wherein the evict-first indicator signals a cache replacement policy to prioritize the one or more cache lines for a subsequent eviction.

9. The method of claim 1, wherein performing the deferred CMO comprises:
initiating a traversal of a plurality of cache lines within the cache memory by a background process; and
identifying the one or more cache lines based on the dataset identifier during the traversal.

10. The method of claim 9, further comprising:
storing the trigger command in a status table; and
creating a snapshot of the status table before initiating the traversal.

11. The method of claim 10, further comprising:
after completing the traversal, clearing the trigger command from the status table based on the snapshot of the status table, so as to render the background process transparent to a user that issued the trigger command.

12. The method of claim 1, wherein performing the deferred CMO comprises:
selecting a victim cache line for eviction from the cache memory;
determining if the victim cache line is associated with the dataset identifier for which the trigger command has been received; and
in response to determining the victim cache line is associated with the dataset identifier, executing the deferred CMO on the victim cache line prior to its eviction.

13. The method of claim 12, wherein executing the deferred CMO on the victim cache line is completed before the victim cache line is overwritten with new data.

14. The method of claim 12, further comprising:
in response to determining that the victim cache line is not associated with a dataset identifier for which a trigger command has been received, propagating the deferred CMO hint and the dataset identifier to a downstream memory component during a write-back of the victim cache line.

15. The method of claim 14, further comprising:
storing the propagated deferred CMO hint and the propagated dataset identifier in a metadata portion of a corresponding data entry within the downstream memory component.

16. The method of claim 1, further comprising:
detecting a race condition wherein a new allocation request is received for a new cache line, the new allocation request being associated with the dataset identifier while the deferred CMO is being performed for the one or more cache lines; and
in response to detecting the race condition, applying a protection mechanism to the new cache line.

17. The method of claim 16, wherein applying the protection mechanism comprises forcing a memory allocation request for the new cache line to become a non-allocate operation, such that new data associated with the non-allocate operation is not written into the cache memory.

18. The method of claim 16, wherein applying the protection mechanism comprises at least one of forcing the new cache line to be non-discardable, or forcing the new cache line to be non-cacheable.

19. The method of claim 18, wherein applying the protection mechanism comprises ignoring the performing of the deferred CMO on the one or more cache lines.

20. The method of claim 18, wherein applying the protection mechanism comprises converting the deferred CMO hint of the one or more cache lines to indicate a flush-only state that requires a write-back.

21. The method of claim 1, wherein the dataset identifier is assigned to the dataset by an operating system or a device driver in response to a request from an application to allocate the dataset.

22. A cache management system comprising:
a cache memory comprising a plurality of cache lines, wherein a metadata portion of at least one of the plurality of cache lines is configured to store a deferred cache maintenance operation (CMO) hint and a dataset identifier to associate the at least one cache line with a dataset; and
a controller coupled to the cache memory;
wherein the controller is configured to associate the dataset with a deferred CMO mode, the controller is configured to receive a trigger command associated with the dataset identifier, and the controller is configured to perform a deferred CMO on one or more of the plurality of cache lines associated with the dataset identifier based on the trigger command.
